(19) United States
(12) Patent Application Publication
(10) Pub. No.: US 2023/0150604 A1
(43) Pub. Date: May 18, 2023

(54) FOLDABLE TOP TUBE ASSEMBLY FOR A BICYCLE

(71) Applicant: Black Bear Licensing Limited, St. Verna (MT)

(72) Inventor: Alexander Allen, Lisbon (PT)

(73) Assignee: Black Bear Licensing Limited, St. Verna (MT)

(21) Appl. No.: 17/524,868

(22) Filed: Nov. 12, 2021

(51) Int. Cl. B62K 15/00

(52) U.S. Cl. CPC B62K 15/006

(57) ABSTRACT

A foldable top tube assembly for a bicycle is provided. The assembly includes a seat post attachment terminus coupled to a first telescoping tubular member, and a headset assembly attachment terminus coupled to a second telescoping tubular member. The overall length of the folded top tube assembly may be about ⅓ the overall length of the fully extended top tube assembly. The assembly further includes a central, hinged tubular member having a first end sized to receive the first telescoping tubular member, and a second end sized to receive the second telescoping tubular member. The assembly may also include a first spring tending to resist extension of the first telescoping tubular member from the first end of the central, hinged tubular member, and a second spring tending to resist extension of the second telescoping tubular member from the second end of the central, hinged tubular member.

### FIELD OF THE INVENTION

The invention relates, in part, to a foldable tube assembly for a bicycle.

### BACKGROUND

There are a variety of types of accessories for a bicycle. One type of accessory is a modular, aftermarket top tube which can be added to a bicycle frame. Although most bicycle frames include a top tube at the time of manufacture some, such as women's step-through frames, do not. A modular, aftermarket top tube may be attached to a bicycle frame manufactured without a top tube, so that the bicycle can be properly installed on a rear-mounted vehicle bicycle carrier.

### SUMMARY OF THE INVENTION

According to one aspect, a modular, aftermarket, foldable top tube assembly for a bicycle is provided. Throughout this application, the modular, aftermarket, foldable top tube assembly will be referred to simply as the foldable top tube assembly. The assembly includes a seat post attachment terminus coupled to a first telescoping tubular member, and a headset assembly attachment terminus coupled to a second telescoping tubular member, where the overall length of the folded top tube assembly is about ⅓ the overall length of the fully extended top tube assembly. The assembly further includes a central, hinged tubular member having a first end sized to receive the first telescoping tubular member, and a second end sized to receive the second telescoping tubular member.

According to another aspect, a foldable top tube assembly for a bicycle is provided. The assembly includes a seat post attachment terminus coupled to a first telescoping tubular member, and a headset assembly attachment terminus coupled to a second telescoping tubular member. The assembly also includes a central, hinged tubular member having a first end sized to receive the first telescoping tubular member, and a second end sized to receive the second telescoping tubular member, where the central, hinged tubular member is movable between a folded storage position and an unfolded position. The assembly further includes a first spring tending to resist extension of the first telescoping tubular member from the first end of the central, hinged tubular member, and a second spring tending to resist extension of the second telescoping tubular member from the second end of the central, hinged tubular member.

### BRIEF DESCRIPTION OF THE DRAWINGS

FIG. 1 is a side view of a bicycle manufactured with a women's step-through frame having a top tube accessory attached to the bicycle frame;

FIG. 2 is a perspective view of one embodiment of a foldable top tube assembly for a bicycle shown in an open position;

FIG. 3 is a perspective view of one embodiment of a foldable top tube assembly for a bicycle shown in a folded position;

FIG. 4 is a side view of one embodiment of a foldable top tube assembly for a bicycle shown in a folded position;

FIG. 5 is a side view of one embodiment of a foldable top tube assembly for a bicycle shown in an open position;

FIG. 6 is a side view of one embodiment of a foldable top tube assembly for a bicycle shown in a fully extended open position;

FIG. 7 is an exploded assembly view of one embodiment of a foldable top tube assembly for a bicycle;

FIG. 8 is a partially exploded view of one embodiment of a foldable top tube assembly for a bicycle; and

FIG. 8A is a detailed transparent view of the area enclosed by arrow A shown in FIG. 8.

### DETAILED DESCRIPTION

The present disclosure is directed to a foldable top tube assembly for a bicycle. The inventor recognized that the current top tube products designed for use with a bicycle are quite large and cumbersome. The inventor recognized that this was undesirable for several reasons. First, shipment costs are high because the product must be shipped in a large box. Second, the large size of the product makes it difficult to display on a store shelf. Lastly, it can be undesirable to the end user to store a large top tube accessory product when not in use.

Aspects of the present disclosure are directed to a foldable top tube assembly for a bicycle. The assembly may be movable between a foldable storage position and an unfolded position for attaching to a bicycle frame. As set forth in more detail below, a foldable assembly enables the product to occupy a smaller volume. This is advantageous because the product can be shipped in a smaller sized box which reduces shipping costs, the smaller footprint of the product enables the product to be more easily displayed on store shelves, and it also enables the end user to more easily store the product when not in use.

The inventor recognized that the foldable top tube assembly should be designed in a way to be adjustable in length to fit a variety of sizes of bicycle frames. The inventor also recognized that it is desirable to have a foldable design that is easy to use, but that is also designed in a way to remain rigid and that will not inadvertently fold up while the product is attached to a bicycle.

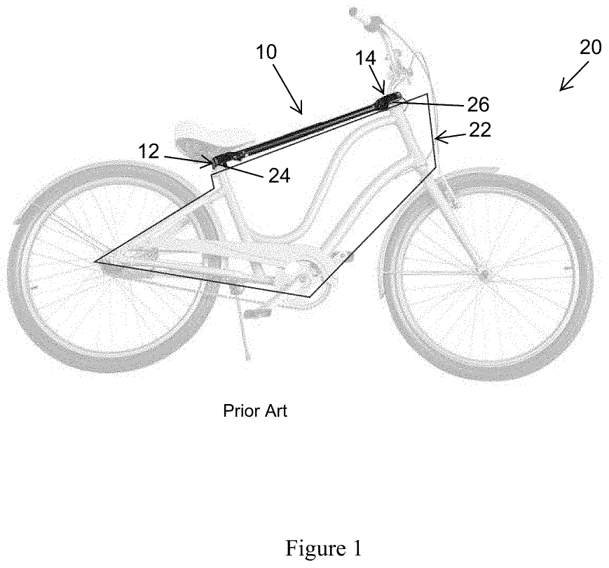

FIG. 1 is a side view of a bicycle 20 with a top tube accessory 10 attached to the bicycle frame 22. The bicycle frame 22 shown in FIG. 1 was manufactured as a women's step-through frame. Such frames lack a conventional top tube which is commonly used to support a bicycle being transported using a top tube supporting rack attached to a vehicle. As shown, one end 12 of the top tube accessory attaches to the seat post 24 of the bicycle frame 22, and the other end 14 of the top tube accessory 10 attaches to the headset 26 of the bicycle frame 22. As shown in FIG. 1, the top tube accessory 10 adds a top tube to the bicycle frame 22 so that it can be properly installed on a rear-mounted, top tube supporting, vehicle bicycle carrier. As mentioned above, the prior art top tube accessory is a rigid, large and cumbersome product.

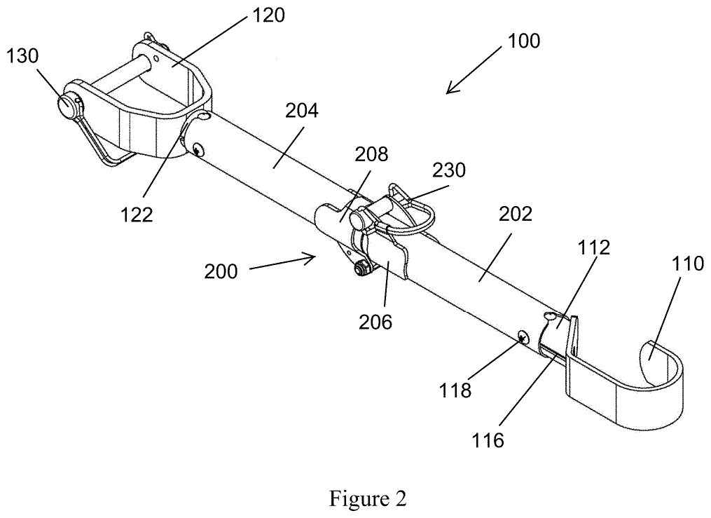

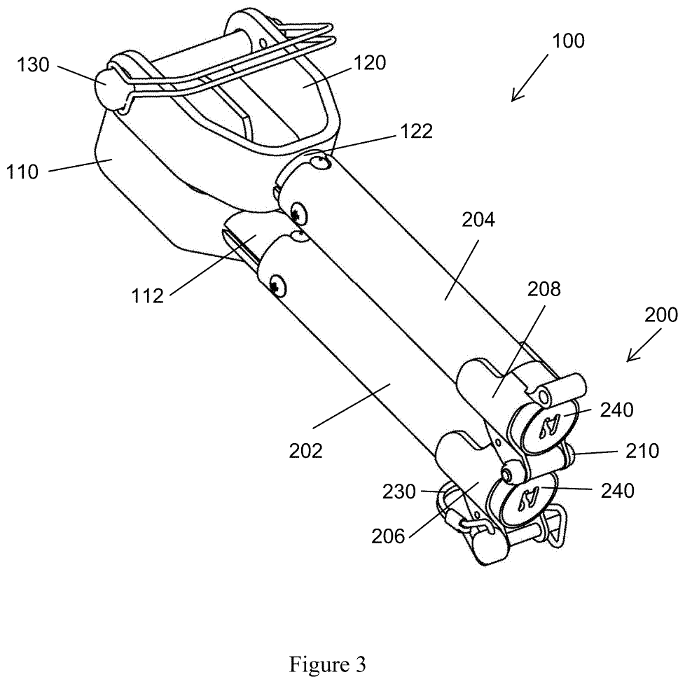

Turning now to FIGS. 2 and 3, one embodiment of a foldable top tube assembly 100 will now be described. The foldable top tube assembly 100 has one end configured to attach to the seat post of a bicycle frame, and a second end configured to attach to the headset assembly of a bicycle frame, typically just below the stem. As shown in the open unfolded position shown in FIG. 2, a seat post attachment terminus 110 is coupled to a first telescoping tubular member 112, and a headset assembly attachment terminus 120 is coupled to a second telescoping tubular member 122. In one illustrative embodiment, the seat post attachment terminus 110 is a substantially J-shaped hook, and the headset assembly attachment terminus 120 is a substantially U-shaped hook. However, one of ordinary skill in the art will appreciate that in another embodiment, each end may be shaped differently as the present disclosure is not limited in this respect. It should be recognized that the seat post attachment terminus 110 may include an inner surface that substantially matches the contour of the seat post 24 on a bicycle 20 (see FIG. 1). Similarly, in one embodiment, the headset assembly attachment terminus 120 includes an inner surface that substantially matches the contour of the headset assembly 26 on a bicycle 20. Furthermore, both ends 110, 120 of the assembly 100 may be coated, for example with rubber or a plastic or vinyl film, to protect the finish of the bicycle.

Furthermore, in one embodiment, at least one of the seat post attachment terminus 110 and the headset assembly attachment terminus 120 includes a locking mechanism 130 configured to lock that end to a bicycle. In the embodiment illustrated in FIGS. 2 and 3, a locking mechanism 130 on the headset assembly attachment terminus 120 is configured to lock the headset assembly attachment terminus 120 to a headset assembly portion of the bicycle. In another embodiment, a locking mechanism may be provided on the seat post attachment terminus 110 to lock the seat post attachment terminus to the seat post portion of a bicycle. Further details of the locking mechanism 130 are discussed below.

As shown in FIGS. 2 and 3, the foldable top tube assembly further includes a central, hinged tubular member 200 having a first end sized to receive the first telescoping tubular member 112, and a second end sized to receive the second telescoping tubular member 122. As shown in FIG. 3, the central hinged tubular member 200 is foldable about a hinge pin 210 and is moveable between a folded storage position and an unfolded position. Details regarding the central hinged tubular member 200 are set forth below.

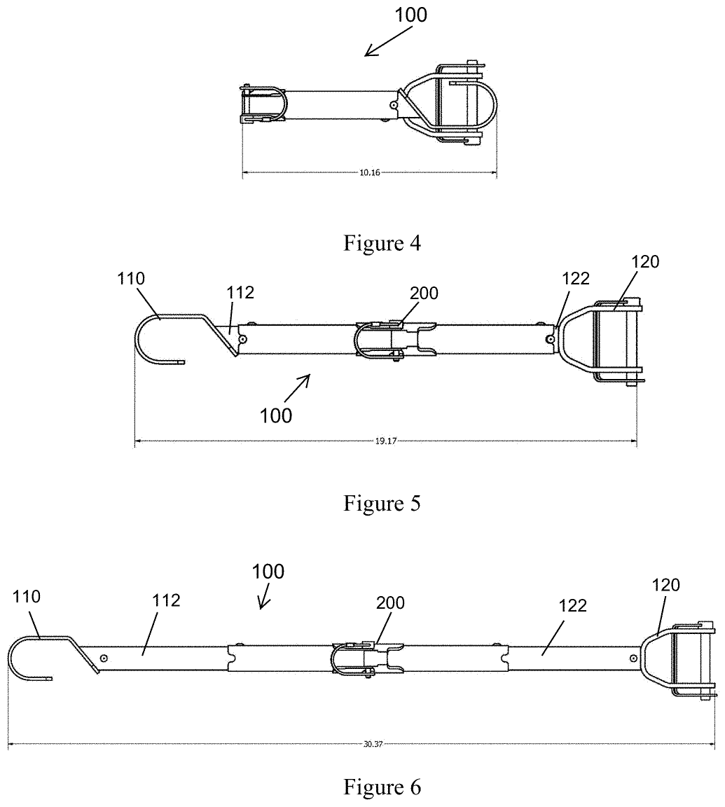

FIG. 4 is a side view of one embodiment of a foldable top tube assembly 100 shown in a folded position. As shown in the folded storage position shown in FIGS. 3 and 4, in one embodiment, the seat post terminus 110 overlaps with the headset assembly attachment terminus 120. FIG. 5 is a side view of the foldable top tube assembly 100 shown in an open position, where the first and second telescoping tubular members 112, 122 are fully retracted within the central hinged tubular member 200. Both the first and second tubular members 112, 122 are moveable within the central hinged tubular member 200 to adjust to the desired overall length. FIG. 6 is a side view of the foldable top tube assembly 100 shown with the first and second tubular members 112, 122 in a fully extended open position.

In one embodiment, the overall length of the folded top tube assembly 100 is about ⅓ the overall length of the fully extended top tube assembly. For example, in one embodiment, the foldable top tube assembly 100 shown in FIG. 4 in a folded position has an overall length of about 10 inches. In contrast, in one embodiment, the foldable top tube assembly 100 shown in FIG. 6 in a fully extended open position has an overall length of about 30 inches. As shown, the overall footprint of the assembly 100 in its folded position is much smaller in comparison to its fully extended position. This is advantageous because the product can be shipped in a smaller sized box which reduces shipping costs, the product can more easily be displayed on store shelves, and the end use can more easily store the product when not in use. As shown in FIG. 5, in one embodiment, the overall length of the assembly 100 in an open retracted position is about 20 inches. In one embodiment, the assembly 100 is configured to adjust to fit bicycles where the distance between the headset assembly and the seat post varies between about 18 inches to about 27 inches. As shown in FIG. 2, the first and second tubular members 112, 122 may each include a slot 116 and a screw 118, or other conventional male fastener, may slide within the slot 116 as the first and second tubular members 112, 122 are extended or retracted to prevent rotation of the seat post attachment terminus 110 and the headset assembly attachment terminus 120 relative to the central hinged tubular member 200.

In one embodiment, the ratio of the maximum unfolded fully extended overall length to the folded overall length is at least 3:1. In another embodiment, the ratio of the maximum unfolded fully extended overall length to the folded overall length is at least 4:1.

As shown in FIGS. 2 and 3, in one illustrative embodiment, the central hinged tubular member 200 includes a third tubular member 202 sized to receive the first telescoping tubular member 112, and a fourth tubular member 204 sized to receive the second telescoping tubular member 122. As shown comparing FIGS. 5 and 6, the overall length of the assembly 100 can be extended by sliding the first and second telescoping tubular members 112, 122 out of their respective third and fourth tubular members 202, 204 of the central hinged tubular member 200. As shown, the central hinged tubular member 200 may also include a first hinge bracket 206 coupled to the third tubular member 202 and a second hinge bracket 208 coupled to the fourth tubular member 204. First and second hinge brackets 206, 208 may be pivotally attached to each other by a hinge pin 210. As shown, the first and second hinge brackets 206, 208 may be configured to wrap at least partially around one end of the third and fourth tubular members 202, 204. The central hinged tubular member 200 may also include a locking mechanism 230 configured to lock the central hinged tubular member 200 in an unfolded extended position.

It should be appreciated that the locking mechanisms 130, 230 may be configured in a variety of ways known to one having ordinary skill in the art. As shown, in one embodiment, the locking mechanism 130 includes a locking bail and pin configuration. Furthermore, in one embodiment, the locking mechanism 230 also includes a locking bail and pin configuration. In another embodiment, other known mechanical locking mechanisms may be implemented as the disclosure is not so limited.

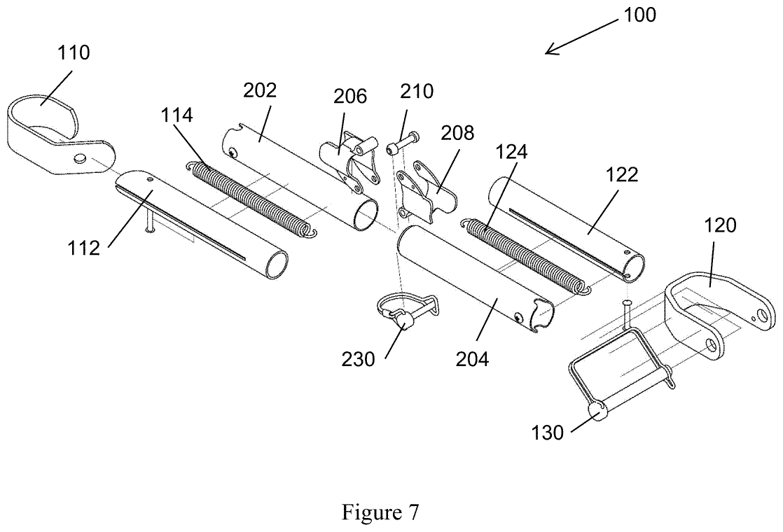

Turning now to the exploded assembly view shown in FIG. 7, some of the internal components of the foldable top tube assembly 100 will now be discussed. In one embodiment, the assembly 100 includes a first spring 114 tending to resist extension of the first telescoping tubular member 112 from the first end of the central hinged tubular member 200. The assembly 100 may also include a second spring 124 tending to resist extension of the second telescoping tubular member 122 from the second end of the central hinged tubular member 200. As shown in FIG. 7, in one illustrative embodiment, the first and second springs 114, 124 are helical springs, with the first spring 114 positioned within the first telescoping tubular member 112, and the second spring 124 positioned within the second telescoping tubular member 122. As shown in FIG. 7, each end of spring 114 may include hook-shaped ends, with one end of the first spring 114 configured to attach to an attachment point near the distal end of the first telescoping tubular member 112, and the other end of the first spring 114 is configured to attach to an attachment point near the hinged portion of tubular member 202. Similarly, each end of second spring 124 may include hook-shaped ends, with one end of the second spring 124 configured to attach to an attachment point near the distal end of the second telescoping tubular member 122, and the other end of the second spring 124 is configured to attach to an attachment point near the hinged portion of the tubular member 204. In another embodiment, other types of spring configurations may also be employed. One of ordinary skill in the art will appreciate that these springs 114, 124 may be configured to maintain constant tension to secure the foldable top tube assembly 100 to a bicycle frame.

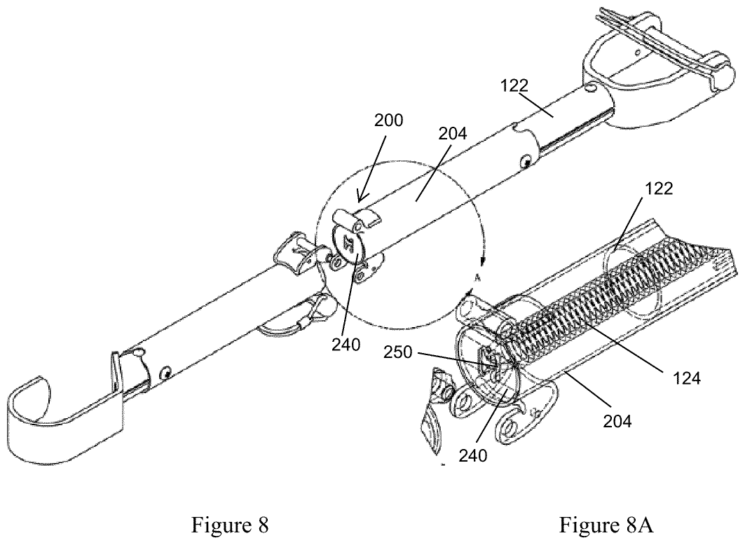

Turning now to FIGS. 8 and 8A, further details regarding the attachment point of the springs 114, 124 within the central hinged tubular member 200 are illustrated. In one embodiment, an end cap 240 may be located on the end of the fourth tubular member 204. As shown in FIG. 3, a similar end cap 240 may also be located on the end of the third tubular member 202. These end caps 240 may enclose the internal components of the assembly. As shown in the detailed transparent view in FIG. 8A, one end of the telescoping tubular member 122 (shown transparent) extends into the fourth tubular member 204 (of the central hinged tubular member 200 and also shown in transparent). As shown in FIG. 8A, the springs 114, 124 may be anchored to an attachment point 250 within the central hinged tubular member 200. In one illustrative embodiment, the attachment point 250 is located on the end cap 240, and may for example include an inwardly extending hook. As also shown in FIG. 8A, in one embodiment, the attachment point 250 is within the first end of the central, hinged tubular member 200, beyond the penetration depth of the telescoping tubular member 122 within the first end of the central, hinged tubular member 200.

In one illustrative embodiment, the above-described first and second telescoping tubular members 112, 122 and the central hinged tubular member 200 each have a substantially cylindrical shape with a substantially circular cross section. In another embodiment, these tubular members 112, 122, 200 may be shaped differently, and may have other cross-sectional shapes, such as but not limited to oval, triangular, square, rectangular cross sections.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A foldable top tube assembly for a bicycle, comprising:
a seat post attachment terminus coupled to a first telescoping tubular member;
a headset assembly attachment terminus coupled to a second telescoping tubular member;
wherein the overall length of the folded top tube assembly is about ⅓ the overall length of the fully extended top tube assembly; and
a central, hinged tubular member having a first end sized to receive the first telescoping tubular member, and a second end sized to receive the second telescoping tubular member.

2. The foldable top tube assembly, as recited in claim 1, further comprising a first spring tending to resist extension of the first telescoping tubular member from the first end of the central, hinged tubular member.

3. The foldable top tube assembly, as recited in claim 2, further comprising a second spring tending to resist extension of the second telescoping tubular member from the second end of the central, hinged tubular member.

4. The foldable top tube assembly, as recited in claim 2, wherein the first spring is anchored to an attachment point within the first end of the central, hinged tubular member, beyond the penetration depth of the first telescoping tubular member within the first end of the central, hinged tubular member.

5. The foldable top tube assembly, as recited in claim 1, wherein the central hinged tubular member further comprises:
a third tubular member sized to receive the first telescoping tubular member;
a fourth tubular member sized to receive the second telescoping tubular member;
a first hinge bracket coupled to the third tubular member; and
a second hinge bracket coupled to the fourth tubular member.

6. The foldable top tube assembly, as recited in claim 1, further comprising a locking mechanism on the central, hinged tubular member configured to lock the central, hinged tubular member in an unfolded position.

7. The foldable top tube assembly, as recited in claim 1, further comprising a locking mechanism on the headset assembly attachment terminus configured to lock the headset assembly attachment terminus to a headset portion of a bicycle.

8. The foldable top tube assembly, as recited in claim 1, wherein in a folded storage position, the seat post attachment terminus overlaps with the headset assembly attachment terminus.

9. The foldable top tube assembly, as recited in claim 1, wherein the seat post attachment terminus is a substantially J-shaped hook.

10. The foldable top tube assembly, as recited in claim 1, wherein the headset assembly attachment terminus is a substantially U-shaped hook.

11. The foldable top tube assembly, as recited in claim 1, wherein the first and second telescoping tubular members and the central, hinged tubular member each have a substantially cylindrical shape.

12. A foldable top tube assembly for a bicycle, comprising:
a seat post attachment terminus coupled to a first telescoping tubular member;
a headset assembly attachment terminus coupled to a second telescoping tubular member;
a central, hinged tubular member having a first end sized to receive the first telescoping tubular member, and a second end sized to receive the second telescoping tubular member, wherein the central, hinged tubular member is movable between a folded storage position and an unfolded position;
a first spring tending to resist extension of the first telescoping tubular member from the first end of the central, hinged tubular member; and
a second spring tending to resist extension of the second telescoping tubular member from the second end of the central, hinged tubular member.

13. The foldable top tube assembly, as recited in claim 12, wherein the first spring is a helical spring positioned within the first telescoping tubular member, and the second spring is a helical spring positioned within the second telescoping tubular member.

14. The foldable top tube assembly, as recited in claim 12, wherein the first spring is anchored to an attachment point within the first end of the central, hinged tubular member, beyond the penetration depth of the first telescoping tubular member within the first end of the central, hinged tubular member.

15. The foldable top tube assembly, as recited in claim 12, wherein the central hinged tubular member further comprises:
a third tubular member sized to receive the first telescoping tubular member;
a fourth tubular member sized to receive the second telescoping tubular member;
a first hinge bracket coupled to the third tubular member; and
a second hinge bracket coupled to the fourth tubular member.

16. The foldable top tube assembly, as recited in claim 12, further comprising a locking mechanism on the central, hinged tubular member configured to lock the central, hinged tubular member in the unfolded position.

17. The foldable top tube assembly, as recited in claim 12, further comprising a locking mechanism on the headset assembly attachment terminus configured to lock the headset assembly attachment terminus to a headset portion of a bicycle.

18. The foldable top tube assembly, as recited in claim 12, wherein in the folded storage position, the seat post attachment terminus overlaps with the headset assembly attachment terminus.

19. The foldable top tube assembly, as recited in claim 12, wherein the seat post attachment terminus is a substantially J-shaped hook.

20. The foldable top tube assembly, as recited in claim 12, wherein the headset assembly attachment terminus is a substantially U-shaped hook.

21. The foldable top tube assembly, as recited in claim 12, wherein the first and second telescoping tubular members and the central, hinged tubular member each have a substantially cylindrical shape.
